(19) United States
(12) Patent Application Publication
(10) Pub. No.: US 2002/0005069 A1
(43) Pub. Date: Jan. 17, 2002

(54) Six degree of freedom magnetically levitated vibration table

(75) Inventor: Stephen B. Nichols, Charlestown, MA (US)

Correspondence Address: Lisa Swiszcz Hazzard, P.O. Box 9169, Boston, MA, 02209, US

(73) Assignee: SatCon Technology Corporation

(21) Appl. No.: 09/846,696

(22) Filed: May 1, 2001

Related U.S. Application Data
(60) Provisional application No. 60/201,063, filed on May 1, 2000.

(51) Int. Cl. G01M 7/06

(52) U.S. Cl. 73/577; 73/662

(57) ABSTRACT

Devices and methods for producing mechanical vibration for the purpose of evaluating the durability or vibration response of a test article. More particularly, the devices and methods produce mechanical vibration of a test fixture without mechanical contact, thereby enabling the evaluation of the durability and vibration response of a test article connected to the test fixture. The device and method are particularly suitable for testing disk drives for portable computers and similar articles.

The present application claims the benefit of U.S. provisional application No. 60/201,063, filed on May 1, 2000.

### FIELD OF THE INVENTION

The present invention relates to improved devices and methods for producing mechanical vibration for the purpose of evaluating the durability or vibration response of a test article connected to the device. More particularly, the test article is connected to a test fixture of the device. The device produces mechanical vibration of the test fixture without mechanical contact, thereby enabling the evaluation of the durability and vibration response of a test article connected to the fixture. The device and method are particularly suitable for testing disk drives for portable computers and similar articles.

### BACKGROUND OF THE INVENTION

New requirements for electro-mechanical product such as disk drives for portable computers require multiple degree of freedom mechanical vibration testing to ensure durability and for diagnostic evaluation. Multiple degrees of freedom vibration input are needed to duplicate the actual vibration environment experienced during the use of these products. Existing vibration machines typically act on a single translational axis. Multiple translational axes of vibration are currently implemented by coupling a number of single axis actuators through complicated mechanical linkages and flexures.

### SUMMARY OF THE INVENTION

The invention comprises the novel application of magnetic levitation technology to create a completely non-contact, six degree of freedom, shaker. The combination of a set of high force magnetic actuators to both support the test article without the need for mechanical contact and to generate the desired vibrational forces about any combination of the six mechanical degrees of freedom of the test article. The non contact magnetic forcing approach results in only one moving part and eliminates the wear problems of sliding contact, the fatigue failure of mechanical flexures and the reliability problems associated with electrical power leads. As all forces are electromechanically generated, all possibilities of lubricant, hydraulic fluid or pneumatic leaks are eliminated. It is also ideally suited to a clean room environment as there is no lubrication required and no mechanical, particle generating, contact.

In one embodiment, the method and apparatus produce mechanical vibration of a test fixture without mechanical contact with the fixture for the purpose of evaluating the durability or vibration response of a test article connected to the fixture.

In another embodiment, the method and apparatus preferably provide vibration of the test article in multiple axis during the same test without the use of pneumatic or hydraulic devices.

In yet another embodiment, the method and apparatus produce a 6 degree of freedom motion for vibration testing, while using only one (1) moving sub-assembly part in which the entire sub-assembly part moves and vibrates in the same direction at the same time in a unidirectional fashion.

In another embodiment, the method and apparatus for producing a mechanical vibration of a test article is designed such that the test article can be vibrated in multiple axis during a single test by using only an electro-dynamic device in which the electro-dynamic device has no moving mechanical sub-assemblies used for interconnecting the electro-dynamic device to the test article other than a single unidirectional subassembly in which the unidirectional subassembly also supports the test articles. In one preferred embodiment, the electro-dynamic device consists of multiple voice coil actuators operating in different axes. In another preferred embodiment, the electro-dynamic device contains multiple sets of permanent magnets on the moving subassembly. In another preferred embodiment, the electro-dynamic device utilizes planer sets of permanent magnets on the moving subassembly. In yet another preferred embodiment, the electro-dynamic device utilizes a pair of fixed coils in each magnet gap to generate forces in two directions with one set of magnets. These fixed coils preferably have an active portion situated in a magnetic gap and a return portion outside of the gap. Alternatively, the magnetic gaps may be fixed and the coils may be the moving subassembly.

In another embodiment, the device used to produce the vibration uses magnetic levitation technology to produce the vibration in which the sub assembly that supports the test article is suspended in space with no mechanical supports and the only means of support is a magnetic field.

In another embodiment, the device used to produce the vibration uses magnetic levitation technology to produce the vibration in which the sub assembly that supports the test article is suspended in space with no mechanical supports and the only means of support is a magnetic field and where an opposing pair of permanent magnet supports the weight due to gravity of the subassembly and test article using magnetic repulsion.

Other advantages are lower cost, low maintenance, small footprint, portability, no moving mechanical subassemblies, and simplicity of manufacture.

### BRIEF DESCRIPTION OF THE DRAWINGS

For a fuller understanding of the nature and desired objects of the present invention, reference is made to the following detailed description taken in conjunction with the accompanying figures wherein like reference character denote corresponding parts throughout the several views and wherein:

FIG. 1 is a perspective view illustrating a six degree of freedom vibration table in accord with one embodiment of the instant invention.

FIG. 2 is a perspective view illustrating an electromagnetic actuator that can be used in accord with another embodiment of the instant invention.

### DETAILED DESCRIPTION OF A PREFERRED EMBODIMENT THEREOF

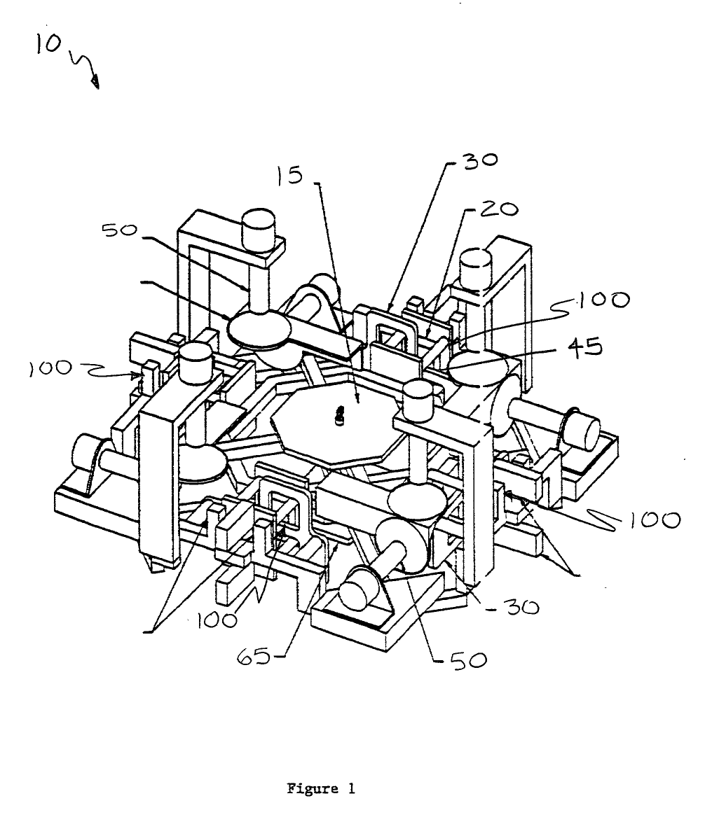

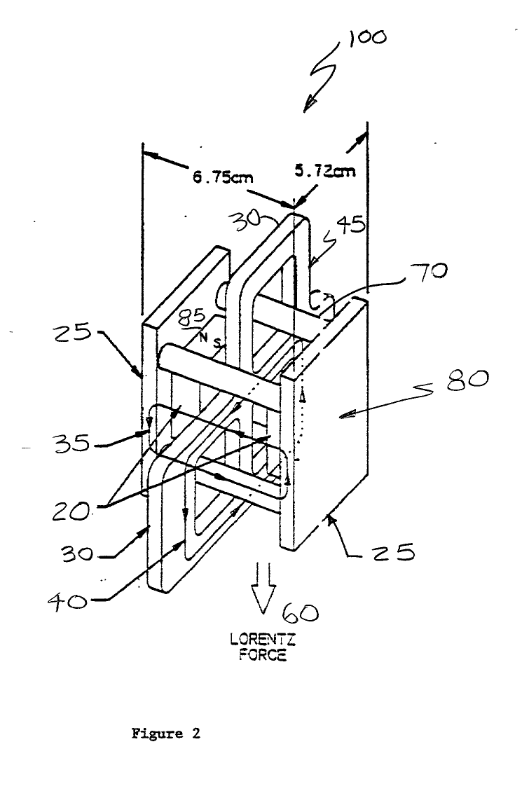

Referring to FIGS. 1 and 2, the vibration table 10 of the present invention preferably comprises a movable platform to which a test article can be mounted. Preferably, the movable platform is disposed between an upper mounting plate 15 and a lower mounting plate 65 about which, further, are disposed an arrangement of several, e.g., four, actuators 100 that produce forces in two, e.g., a vertical and a tangential, axes.

In one embodiment, the actuators 100 comprise a pair of permanent magnets 20, e.g., rare earth-type magnet, that are disposed substantially diametrically opposed to one another. As a result, the disposition of the magnets 20 produces a flux field that is radially oriented. Accordingly, the magnets 20 can produce force 60 in two, e.g., vertical and tangential, axes in a manner that will be described below.

The permanent magnets 20 are fixedly attached to a fixed frame 80 at the inner face 85 of a pair of mounting plates 25. The mounting plates 25 are further separated by and fixedly attached to a number, e.g., four, positioning posts 70.

Further disposed between the mounting plates 25 and permanent magnets 25 preferably is a coil assembly 45 with a number, e.g., two, electrical current carrying coils 30. Current 40 passing through the fixed coils 30 induces a magnetic flux field 35, which flux field 35 interacts with, e.g., adds to or subtracts from, the magnetic field of the magnets 20 to generate levitation and vibration forces 60 on the platform. Indeed, in a preferred embodiment, the two fixed coils 30 are oriented substantially perpendicular to the radially oriented magnetic flux from the permanent magnets 20. Accordingly, forces 60 in vertical and tangential directions result.

The coil currents 40 are generated, e.g., by one or more power amplifiers (not shown) in respond to command signals from an electronic controller (not shown). For example, the electronic controller generates command signals to the power amplifiers based on the desired vibration profile and the position of the platform relative to the fixed frame 80 as indicated by a set of position sensors 50 located in the frame.

The foregoing description of the invention is merely illustrative thereof, and it is understood that variations and modifications can be effected without departing from the scope or spirit of the invention as set forth in the following claims.

What is claimed is:

1. A method and apparatus for producing mechanical vibration of a test fixture without mechanical contact with the fixture for the purpose of evaluating the durability or vibration response of a test article connected to the fixture.

2. A method and apparatus for producing mechanical vibration of a test article in which the test article can be vibrated in multiple axis during the same test without the use of pneumatic or hydraulic devices.

3. A method and apparatus for producing a 6 degree of freedom motion for vibration testing with the use of only one (1) moving sub-assembly part in which the entire sub-assembly part moves and vibrates in the same direction at the same time in a unidirectional fashion.

4. A method and apparatus for producing a mechanical vibration of a test article in which the test article can be vibrated in multiple axis during a single test by using only an electro-dynamic device in which the electro-dynamic device has no moving mechanical sub-assemblies used for interconnecting the electro-dynamic device to the test article other than a single unidirectional subassembly in which the unidirectional subassembly also supports the test article.

5. A method and apparatus for producing a mechanical vibration of a test article in which the device used to produce the vibration uses magnetic levitation technology to produce the vibration in which the sub assembly that supports the test article is suspended in space with no mechanical supports and the only means of support is a magnetic field.

6. A method and apparatus for producing a mechanical vibration of a test article in which the device used to produce the vibration uses magnetic levitation technology to produce the vibration in which the sub assembly that supports the test article is suspended in space with no mechanical supports and the only means of support is a magnetic field and where an opposing pair of permanent magnet supports the weight due to gravity of the subassembly and test article using magnetic repulsion.

7. The method or apparatus of claim 4 where the electro-dynamic device consists of multiple voice coil actuators operating in different axes.

8. The method and apparatus of claim 4 where the electro-dynamic device contains multiple sets of permanent magnets on the moving subassembly.

9. The method and apparatus of claim 4 where the electro-dynamic device utilizes planer sets of permanent magnets on the moving subassembly.

10. The method and apparatus of claim 4 where the electro-dynamic device utilizes a pair of fixed coils in each magnet gap to generate forces in two directions with one set of magnets.

11. The method and apparatus of claim 10 where the fixed coils have an active portion situated in a magnetic gap and a return portion outside of the gap.

12. Any of the above where the magnetic gaps are fixed and the coils are on the moving subassembly.
